(19) United States
(12) Patent Application Publication
(10) Pub. No.: US 2003/0077506 A1
(43) Pub. Date: Apr. 24, 2003

(54) Enclosed layered stack, method for producing said enclosed layered stack and use of said method

(76) Inventors: Hartmut Michel, Heidenheim (DE); Klaus Schoch, Nattheim (DE); Werner Erhardt, Ballendorf (DE)

Correspondence Address: SCHIFF HARDIN & WAITE, 6600 SEARS TOWER, 233 S WACKER DR, CHICAGO, IL, 60606-6473, US

(21) Appl. No.: 10/240,007

(22) PCT Filed: Mar. 15, 2001
(86) PCT No.: PCT/DE01/01013

(30) Foreign Application Priority Data
Mar. 30, 2000 (DE) 100 15 823.4

(51) Int. Cl. H01M 6/10; H01M 2/18; H01M 10/04; H01M 2/02

(52) U.S. Cl. 429/94; 429/130; 29/623.1; 429/128; 429/176; 429/34

(57) ABSTRACT

The invention is directed to a housed layer stack as well as to a method for manufacturing the housed layer stack composed of a band material (1) and a plurality of intermediate layers (2) comprising the following steps:

a) winding the band material (1) onto a winding arbor (3) to form a multi-ply winding, whereby the intermediate layers (2) are bent by at most 180° during the winding and are arranged above one another between the winding plies (4);

b) squeezing the layer stack into a housing (6) such that the intermediate layers (2) are pressed buckling-free against a lateral surface (5) of the housing (6).

The invention is also directed to the employment of the method for the manufacture of batteries, accumulators or capacitors. The invention can be especially advantageously applied for the manufacture of electrolytic capacitors having a cuboid housing.

The invention is directed to a housed layer stack with intermediate layers and to a method for the manufacture of the housed layer stack. The invention is also directed to the employment of this method.

Known methods for manufacturing housed layer stacks such as, for example, winding or stacking, are particularly employed for the manufacture of batteries, accumulators or electrolytic capacitors. An electrolytic capacitor is essentially composed of a stack of anode and cathode plates that lie on top of one another in alternation and between which an absorbent, electrically non-conductive insulating layer such as, for example, paper is respectively arranged. The insulating layer is saturated with a liquid electrolyte. The anodes and the cathodes are pressed together by installing the layer stack in a housing, whereby care must be exercised to see to a uniform pressing power over the entire crossectional area of the stack. This demand derives therefrom that the conduction mechanism in the electrolyte is inhibited compared to the conduction of electrons in metals, as a result whereof the distance over which charges are to be transported by means of ions must be accorded especially great significance. In order to obtain securely defined, uniform component properties, accordingly, it is important that the distance between the electrodes (anode and cathode) is as uniform as possible. Further, a geometry of the housing that is very easy to stack is demanded, whereby a good exploitation of the occupied volume must be adhered to particularly when interconnecting a plurality of capacitors. Cylindrical housings are unsuitable in this respect, whereas housings limited by plane surfaces such as, for example, cuboids are to be preferred.

A known method for manufacturing housed layer stacks is comprised in winding four bands on top of one another onto a round winding. Two of the bands can, for example, thereby be metallic and the remaining bands can be an absorbent, insulating material. After the removal of the winding arbor, the winding that is thereby produced has the shape of a hollow cylinder that is then preferably pressed into a cylindrical housing. This procedure has the disadvantage that the housing shape is not optimum for the exploitation of the space when interconnecting a plurality of housed layer stacks.

Another possibility is comprised in pressing the winding that has been produced into a prismatic housing. As a result thereof, the bands are buckled or, respectively, stretched or crushed, particularly in the edge regions of the housing. This is disadvantageous when the bands are the metallic electrode of a capacitor since these bands react very sensitively to buckling and are thereby often damaged.

Another known method for manufacturing housed layer stacks is comprised in simply stacking the individual layers on top of one another. Although damage to sensitive metal electrodes can be prevented in this way, this method is extremely difficult to realize in fabrication-oriented terms and, in particular, is not suited for the manufacture of great numbers of units.

It is therefore a goal of the present invention to offer a housed layer stack with which damage to metal electrodes is avoided. Another objective is to offer a method with which the housed layer stacks can be simply and quickly manufactured without damaging the layers upon installation in a housing.

This object is inventively achieved by a housed layer stack according to claim 1. A method for manufacturing the housed layer stack and an employment of this method can be derived from the further claims.

The invention specifies a housed layer stack with intermediate layers that lie above one another and are separated from one another and between which a wound band material proceeds and that are pressed buckling-free against a lateral surface of a housing.

Such a layer stack has the advantage that the intermediate layers cannot be damaged by buckling. Further, the layer stack has the advantage that it can be manufactured with a combined winding/stacking method.

The invention also specifies a method for manufacturing a housed layer stack that represents a combination of winding and stacking. The point of departure for the method is formed, on the one hand, by a band material and, on the other hand, by a plurality of intermediate layers. In a first step, the band material is wound onto a winding arbor, whereby a multi-ply winding arises. During the winding, the intermediate layers are arranged above one another between two respective winding plies, so that band material and intermediate layers lie on top of one another in alternation. Care is thereby exercised to see that the intermediate layers on the winding arbor are bent by at most 180 degrees. In a further step, the layer stack manufactured in this way is squeezed into a housing, so that the intermediate layers are pressed against a lateral surface of the housing. As a result thereof that the bending of the intermediate layers does not exceed 180 degrees, the squeezing of the layer stack can ensue such that the intermediate layers are pressed together free of buckling. This inventive method has the advantage that, despite employing a winding process that is simple to implement, the intermediate layers are pressed flat against one another without exerting compressive or tensile stresses and without buckling.

According to the invention, a round winding arbor can, in particular, be employed whose diameter is at least three times as great as the width of the intermediate layers. A plurality of intermediate layers fit side-by-side on the circumference of such a winding arbor, so that a plurality of stacks of intermediate layers can be applied on a winding arbor. To that end, a plurality of intermediate layers must be arranged side-by-side at the circumference of the winding arbor on a wound ply of the band material. After the winding has been finished, the band material is parted between the stacks of intermediate layers lying next to one another. Extremely high unit numbers of layer stacks can thus be simultaneously produced by employing an arbitrarily large winding arbor.

Instead of a round winding arbor, a winding arbor whose crossection inventively comprises a regular polygon can also be especially advantageously employed, whereby the side lengths of the polygon are equal to the width of the intermediate layers. The positioning of the intermediate layers on a respective side of the polygon takes on an especially simple form on such a winding arbor. Moreover, the intermediate layers are placed flat on the arbor and are also not curved during the wrapping of the arbor. This guarantees a minimal mechanical stressing of the intermediate layers.

Further, it is especially advantageous to employ a round winding arbor whose diameter is at least half as large as the width of the intermediate layers. Given such a winding arbor, a respective stack of intermediate layers lying on top of one another is arranged on opposite sides. After the winding has been finished, the winding is pulled from the winding arbor and installed into the housing in its compressed condition. A housed layer stack can be manufactured especially fast with such a method.

It can be especially advantageous to also employ a flat winding arbor for producing the layer stack, whereby the width of the winding arbor is equal to the width of the intermediate layers. A respective stack of intermediate layers is then arranged at the broad sides of the winding arbor that lie opposite one another. This method upon employment of a flat winding arbor again has the advantage that the intermediate layers need not be bent or must only be minimally bent.

Given employment of a flat winding arbor, a method can also be especially advantageously considered wherein a two-ply band material whose plies are spread V-shaped when wound is inventively employed. A respective intermediate layer can thereby be arranged on one side of the winding arbor between the uppermost winding ply and the inner ply of the band material as well as between the inner and the outer ply of the band material. Such a method has the advantage that it allows a manufacture of a layer stack that is twice as fast. Over and above this, a two-ply band is more tear-resistant than a single-ply one and can therefore be stretched more during winding.

Given employment of a two-ply band material, it is especially advantageous when the two plies of the band material are inventively wound offset by half a revolution of the winding arbor. Intermediate layers can then be arranged between the plies of the band material at opposite sides of the winding arbor. This is particularly advantageous when two different kinds of intermediate layers are employed in the manufacture of the housed layer stack. This, for example, is the case when manufacturing an electrolytic capacitor wherein anode intermediate layers alternate with cathode intermediate layers. One kind of intermediate layer can then be supplied at each side of the winding arbor and be arranged between the plies of the band material. The two positions at which the respective kind of intermediate layer is arranged are spatially separated from one another, so that advantages derive therefrom especially in view of the machine technology (supplying intermediate layers from magazines).

The inventive method can be especially advantageously employed for manufacturing batteries, accumulators or capacitors, wherein the optimum exploitation of the available space is important even given interconnection of a plurality of batteries, accumulators or capacitors, since said method allows damage-free installation of the layer stack into a housing that is limited by parallel walls and that can therefor be stacked.

The invention is explained in greater detail below on the basis of exemplary embodiments and the Figures pertaining thereto.

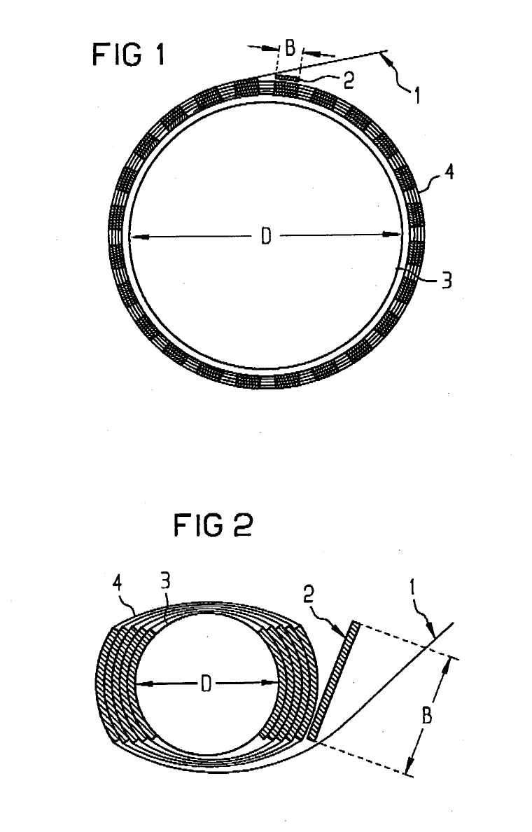

FIG. 1 shows an inventive method upon employment of a large winding arbor in a schematic crossection.

FIG. 2 shows an inventive method upon employment of a small winding arbor in schematic crossection.

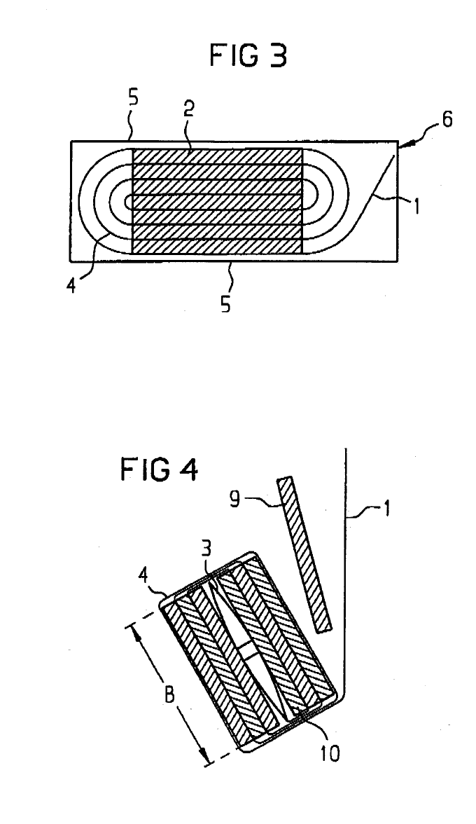

FIG. 3 shows an inventive layer stack that is manufactured according to the method shown in FIG. 2.

FIG. 4 shows an inventive method upon employment of a flat arbor in schematic crossection.

FIG. 5 shows a inventive method upon employment of a two-ply band material in schematic crossection.

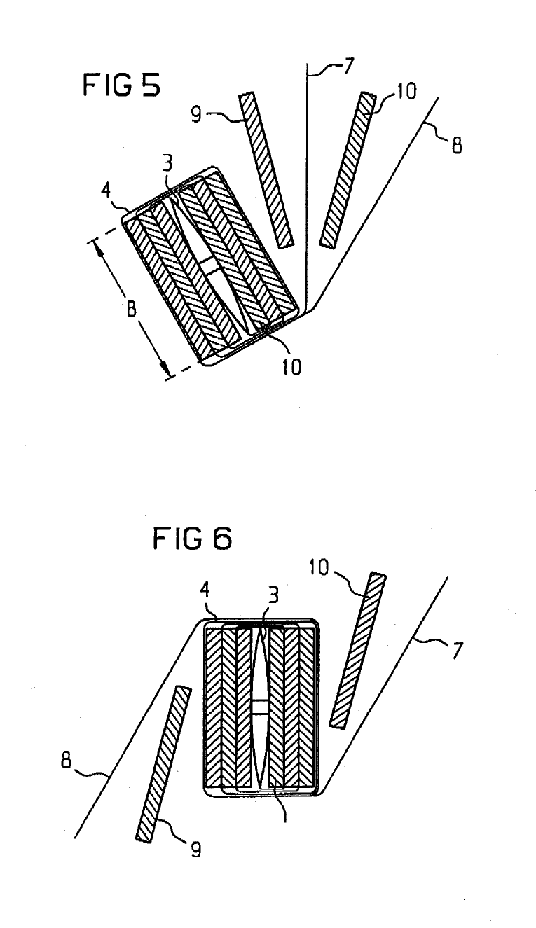

FIG. 6 shows an inventive method upon employment of a two-ply band, whereby the two plies of the band are wound up offset by half a revolution of the winding arbor.

FIG. 1 shows an inventive method for manufacturing a housed layer stack, whereby a band material 1 is wound onto a round winding arbor 3 having a diameter D of 0.5 m. The winding arbor is preferably composed of steel since this material has the needed mechanical stiffness. In the manufacture of electrolytic capacitors, for example, an absorbent layer like paper composed of cellular material or a fleece of polytetrafluorethylene comes into consideration as band material. During the winding of the band material 1 onto the winding arbor 3, intermediate layers 2 are placed onto the respectively outermost wound ply 4. During the winding, a tensile stress is exerted on the band material 1, so that the intermediate layers need be additionally fixed but are fixed solely on the basis of the pressing power that the tensed band material 1 exerts on the winding arbor 3. In the manufacture of an electrolytic capacitor, for example, the band material is of such a nature that its capillary forces enable it to absorb a liquid electrolyte. The width B of the intermediate layers 2 amounts, for example, to 1.5 cm, so that approximately 50 layer stacks can be manufactured on the exemplary winding arbor 3 with a diameter of 0.5 m. The thickness of the band material 1 typically amounts to between 50 and 500 μm. The intermediate layer 2 can represent a metal electrode as required, for example, in the manufacture of electrolytic capacitors. metals such as copper, aluminum or nickel particularly come into consideration. Further, it may potentially be meaningful to roughen the metallic intermediate layers 2, for example by means of electrolysis. For the employment as electrodes in batteries or, respectively, accumulators, metal electrodes that are coated with manganese oxide or nickel oxide or, respectively, carbon also come into consideration. The thickness of the intermediate layers 2 amounts to between 50 and 500 μm. In a preferred embodiment, they have an approximately quadratic crossection, so that their length corresponds to the width B. For electrical contacting, the intermediate layers 2 can be provided with terminal lugs that, for example, point in axial direction of the winding arbor 3. It can be advantageous in the manufacture of a capacitor to respectively conduct the terminal lugs of those intermediate layers 2 that form a common electrode out toward, for example, the front, whereas those terminal lugs of the intermediate layers 2 that form the other electrode are conducted out of the winding toward the back. A problem-free contacting is thus possible with a respective wire forming a terminal pin of the capacitor. For the manufacture of electrolytic capacitors, the band material 1 is of such a nature that it exerts capillary forces on liquids that are capable of saturating the entire band material 1 lying between two intermediate layers 2 with electrolyte. Organic solvents that are laced with conductive salts particularly come into consideration as electrolyte.

FIG. 2 shows an inventive manufacturing method for a housed layer stack, whereby a winding arbor 3 whose diameter D is about half as large as the width B of the intermediate layers 4 is employed. The band material I is wound onto the round winding arbor 3. During the winding, respective intermediate layers 2 are arranged between the wound plies 4 at opposite sides of the winding arbor. After the winding has been finished, the winding arbor 3 can be pulled out of the winding, as a result whereof an essentially hollow cylinder arises that can be pressed flat. The winding pressed flat in this way can be installed in a cuboid housing 6 wide parallel lateral surfaces 5, as a result whereof the intermediate layers 2 are firmly pressed against one another (see FIG. 3). After the winding has been built into the housing 6, the band material 1 can be filled with a liquid electrolyte.

FIG. 3 shows an inventive, housed layer stack that is installed in a housing 6. The layer stack is composed of intermediate layers 2 lying above one another that are separated from one another by a wound band material 1 that comprises different wound plies 4. The layer stack is clamped between the parallel lateral surfaces 5 of the housing 6. Having parallel lateral surfaces 5, the housing 6 can be stacked very easily and in space-saving fashion. The layer stack can especially advantageously be an electrochemical component with metal electrodes that dare not be buckled. An electrolytic capacitor particularly comes into consideration as component.

FIG. 4 shows an inventive method for manufacturing a housed layer stack upon employment of a flat winding arbor 3 and two different kinds 9, 10 of intermediate layers. The width of the winding arbor 3 corresponds to the width of the intermediate layers 9, 10. Two different kinds of intermediate layers 9, 10 occur, for example, in the manufacture of electrolytic capacitors, whereby the first kind of intermediate layers 9 forms the anode of the capacitor and the second kind of intermediate layers 10 forms the cathode of the capacitor. The band material 1 is wound onto the flat winding arbor 3. During the winding, the intermediate layers 9, 10 are placed in stacks between the band material and the outermost wound ply 4 at opposite sides of the winding arbor 3.

FIG. 5 shows an inventive method for manufacturing a housed layer stack upon employment of a flat winding arbor 3 and a two-ply band material 7, 8. When winding the band material 7, 8, the inner ply 7 is spread away from the outer ply 8 V-shaped, so that a first kind of intermediate layers 9 can be arranged between the inner ply of the band material 7 and the outermost wound ply 4 and a second kind of intermediate layers 10 can be arranged between the plies of the band material 7, 8. As a result of this specific procedure, the number of intermediate layers 9, 10 introduced into the stack per revolution is doubled.

FIG. 6 shows a method for the manufacture of a housed layer stack according to FIG. 5, whereby, however, the inner ply of the band material 7 and the outer ply of the band material 8 are wound on offset by half a revolution of the winding arbor 3. This has the machine-oriented advantage that two different kinds of intermediate layers 9, 10 can be inserted between the plies of the band material 7, 8 proceeding from positions that are spatially separated from one another. The various kinds of intermediate layers 9, 10 are supplied from opposite sides of the winding arbor 3.

The invention is not limited to the embodiments that have been shown by way of example but is defined in its most general form by claims 1 and 2.

1. Housed layer stack with intermediate layers (2) that lie above one another and are separated from one another and between which a wound band material (1) proceeds and that are pressed buckling-free against a lateral surface (5) of a housing (6).

2. Method for manufacturing a housed layer stack of a band material (1) and a plurality of intermediate layers (2), comprising the following steps:
a) winding the band material (1) onto a winding arbor (3) to form a multi-ply winding, whereby the intermediate layers (2) are bent by at most 180° during the winding and are arranged above one another between the winding plies (4);
b) squeezing the layer stack into a housing (6) such that the intermediate layers (2) are pressed buckling-free against a lateral surface (5) of the housing (6).

3. Method according to claim 2, whereby a round winding arbor (3) is employed whose diameter (D) is at least three times as great as the width (B) of the intermediate layers (2) and at whose circumference a plurality of intermediate layers (2) are arranged side-by-side on a wound ply, and whereby, after the winding has been finished, the band material (1) is parted between the stacks of intermediate layers (2) lying next to one another.

4. Method according to claim 3, whereby a winding arbor (3) whose crossection comprises a regular polygon is employed, the side lengths of said polygon being equal to the width (B) of the intermediate layers (2).

5. Method according to claim 2, whereby a round winding arbor (3) is employed whose diameter (D) is at least half as large as the width (B) of the intermediate layers (2) and on whose opposite sides a respective stack of intermediate layers (2) lying on top of one another is arranged, and whereby the winding is pulled from the winding arbor (3) after it has been finished.

6. Method according to claim 2, whereby a flat winding arbor (3) is employed whose width is equal to the width (D) of the intermediate layers (2) and at whose broad sides a respective stack of intermediate layers (2) is arranged.

7. Method according to claim 6, whereby a two-ply band material (1) whose plies (7, 8) are spread V-shaped when wound is employed, and whereby a respective intermediate layer (2) is arranged on one side of the winding arbor (3) between the uppermost winding ply (4) and the inner ply (7) of the band material and between the inner and the outer ply (8) of the band material (1).

8. Method according to claim 7, whereby the plies of the band material (7, 8) are wound offset by half a revolution of the winding arbor (3), and whereby a respective intermediate layer (2) is arranged between the plies (7, 8) of the band material (1) at opposite sides of the winding arbor (3).

9. Method according to claim 8, whereby two kinds of intermediate layers (9, 10) are employed, and whereby the first kind (9) is applied proceeding from one side of the winding arbor (3) and the second kind (10) is applied onto the winding proceeding from the opposite side of the winding arbor (3).

10 Method according to claim 2 through 9, whereby a cuboid housing (60 is employed.

11. Method according to claim 2 through 10, whereby a steel winding arbor (3) is employed.

12. Method according to claim 2 through 1 1, whereby copper, aluminum or nickel layers are employed as intermediate layers (2).

13. Method according to claim 2 through 12, whereby a band of absorbent synthetic material or cellular material or composed of a polytetrafluorethylene membrane is employed as band material (1).

14. Method according to claim 13, whereby the band material (1) is filled with a liquid electrolyte after the layer stack has been squeezed into the housing (6).

15. Employment of the method according to claim 2 through 14 for the manufacture of batteries, accumulators or capacitors.
